(19) United States
(12) Patent Application Publication
(10) Pub. No.: US 2009/0080442 A1
(43) Pub. Date: Mar. 26, 2009

(54) CONSERVING POWER IN A MULTI-NODE ENVIRONMENT

(76) Inventors: Ananth S. Narayan, Koramangala (IN); Rajeev D. Muralidhar, Bangalore (IN)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/239,487

(22) Filed: Sep. 26, 2008

(30) Foreign Application Priority Data
Sep. 26, 2007 (IN) 2159/CHE/2007

(51) Int. Cl. H04L 12/28

(52) U.S. Cl. 370/400

(57) ABSTRACT

A coordinated mechanism to conserve power in a multi-node environment is disclosed. A multi-node environment may comprise multiple individual computer systems coupled by a network or, a shared memory architecture multiprocessors, or many-core computers. The power management features of the processor, platform elements, and the devices may be used to conserve power in a multi-node environment. A master node may determine the task and slave nodes required to perform the task and may wake-up the slave nodes required to perform the task while causing the other slave nodes to enter or continue in the sleep-state. The slave nodes, which are woken in-turn may determine the components of the slave nodes required for performing the assigned task and may cause other components to enter a sleep-state.

This application claims priority to Indian Application Number 2159/CHE/2007, titled “CONSERVING POWER IN A MULTI-NODE ENVIRONMENT”, filed Sep. 26, 2007.

### BACKGROUND

A multi-node environment may comprise multiple computing nodes as in a high performance computing cluster (HPC). The computing nodes may be individual computers coupled to each other over a network or shared memory multiprocessors, or many core computers, or any other similar computer systems. The multi-node environments may be used in weather forecasting, search engines, scientific applications, and other similar applications. The multi-node environment may consume huge power in the order of hundreds of mega-waits. Such huge power consumption may generate enormous heat and may also be cost prohibitive.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates a multi-node environment 100.

FIG. 2 illustrates an embodiment of a master node conserving power in the multi-node environment 100.

FIG. 3 illustrates an embodiment of a slave node conserving power in the multi-node environment 100.

### DETAILED DESCRIPTION

The following description describes conserving power in a multi-node environment. In the following description, numerous specific details such as logic implementations, or duplication implementations, types and interrelationships of components are set forth in order to provide a more thorough understanding of the present invention. It will be appreciated, however, by one skilled in the art that the invention may be practiced without such specific details. In other instances, structures have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

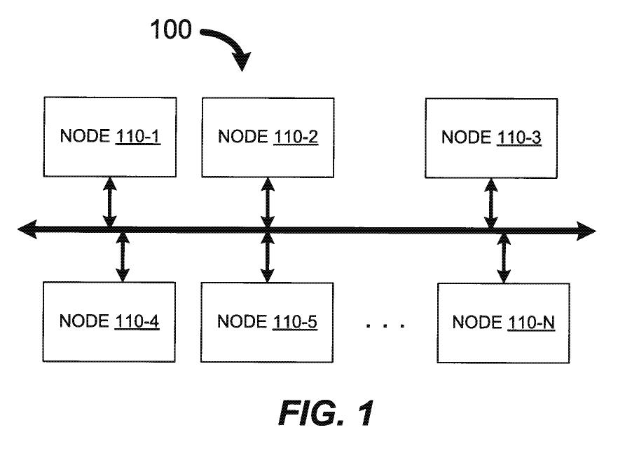

An embodiment of a multi-node environment 100 is illustrated in FIG. 1. In one embodiment, the multi-node environment 100 may comprise nodes 110-1 to 110-N. In one embodiment, the nodes 110 may represent networked computers, individual computers, traditional architectures like shared memory multi-processors, or many-core computers, which may comprise many processing cores in a single die. In one embodiment, the multi-node environment 100 may comprise a server farm or data centers provisioned by organizations such as Google®, Microsoft®, Yahoo®). In one embodiment, the multi-node environment 100 may comprise a high performance cluster (HPC) to perform data modeling, weather forecasting, space exploration, and such other similar applications.

In one embodiment, the nodes 110 may comprise a central processing unit (CPU), a chipset, memory, I/O devices such as a network interface card (NIC), keyboard, mouse, video and audio devices, and such other similar devices. In one embodiment, the nodes 110 may comprise computer systems which may use Intel® IA-32, or IA-64, or IA-EM64T architecture. In one embodiment, the nodes 110 may perform computationally intensive tasks. In one embodiment, the tasks performed by the nodes 110 may comprise a data scatter task, a data crunching task, a synchronization task, and a data gather task.

In one embodiment, one or more of the nodes 110 may be assigned as a master node. In one embodiment, the node 110-1 may be assigned as the master node and the nodes 110-2 to 110-N may operate as slave nodes. In one embodiment, the master node 110-1 and the slave nodes 110-2 to 110-N may coordinate the power management features to conserve the power in the multi-node environment.

In one embodiment, the master node 110-1 may perform data scatter, data gather, and other administrative tasks. In one embodiment, the master node 110-1 may assign sub-tasks to various slave nodes 110-2 to 110-N. In one embodiment, the master node 110-1 may gather and collate the results received from the slave nodes 110-2 to 110-N. In one embodiment, the master node 110-1 may also perform book keeping to record the status of the nodes 110. In one embodiment, the slave nodes 110-2 to 110-N may perform the data crunching tasks and synchronization tasks. In one embodiment, to synchronize, the slave node 110-2 may generate an output after receiving an input from the slave node 110-N and 110-2 may wait for a pre-configured time period until the slave node 110-N generates an output.

In one embodiment, the nodes 110 may support power management features. In one embodiment, while using the power management features, the nodes 110 may be powered down to low-power modes if the activity on the nodes 110 is low. In one embodiment, the power management features may be applicable to sub-nodes such as a software stack, an operating system, a processor, a memory, a chipset, platform buses like universal serial bus (USB) and peripheral component interconnect (PCI), hard disk drive (HDD), networking devices like Ethernet, and such other similar components.

In one embodiment, the nodes 110 may support power management features such as the Advanced Configuration Power Interface (ACPI) features such as the system power states (S1 to S5) and device power states (D0-D3). In one embodiment, the power state D0-D3 of a device may be based on the system power state (S1-S5). In one embodiment, the processor power management features may comprise operating a processor at different frequencies such as P-states and low-power states such as C states. In one embodiment, the power management features may comprise operating a memory in self-refresh mode. In one embodiment, the power management features may comprise operating the hard-disk drive in power off mode.

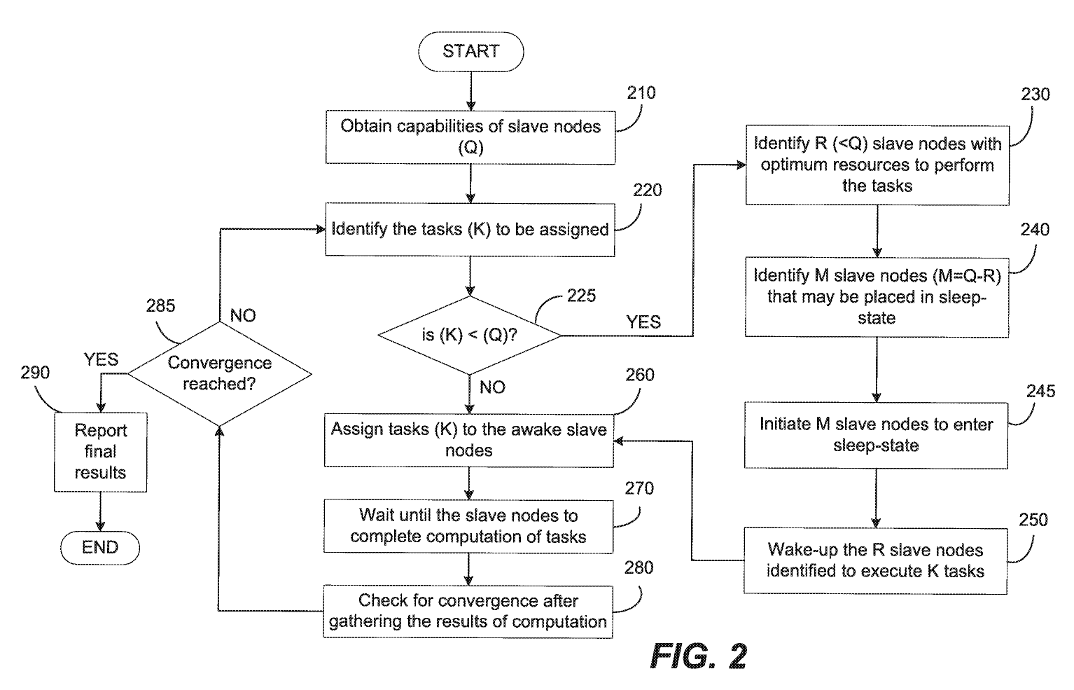

An embodiment of a master node 110-1 conserving the power of a multi-node environment 100 is illustrated in FIG. 2.

In block 210, the master node 110-1 may obtain the capabilities of the slave nodes 110-2 to 110-N. In one embodiment, the master node 110-1 may send a broadcast packet to the slave nodes 110-2 to 110-N. In one embodiment, the broadcast packet may comprise one or more fields, which may be configured by the slave nodes 110-2 to 110-N.

In one embodiment, the master node 110-1 may receive packets from the slave nodes 110-2 to 110-N and may retrieve the configured field values. In one embodiment, the master node 110-1 may generate a table, which may comprise a node identifier of the slave nodes 110-2 to 110-N and the capability of such nodes.

In block 220, the master node 110-1 may identify the tasks to be assigned to the slave nodes 110-2 to 110-N. In one embodiment, the master node 110-1 may, for example, receive a search criteria and may identify different portions of the database that may be traversed by different slave nodes 110-2 to 110-N. In one embodiment, the master node 110-1 may identify ‘K’ tasks.

In block 225, the master node 110-1 may check whether the tasks identified in block 220 is less than the available slave nodes 110-2 to 110-N and control passes to block 230 if the identified tasks are less than the slave nodes 110-2 to 110-N and to block 260 otherwise. In one embodiment, the number of slave nodes 110-2 to 110-N may equal (Q). In one embodiment, the master node 110-1 may compare K and Q before the control passes to block 230 or 260.

In block 230, the master node 110-1 may identify one or more slave nodes 110-2 to 110-N with optimum resources to perform the tasks. In one embodiment, the master node 110-1 may chose ‘R’ (<Q) nodes from 110-1 to 110-N to search different portions of the database.

In block 240, the master node 110-1 may identify M (=Q-R) slave nodes 110-2 to 110-N, which may be placed in sleep-state. In block 245, the master node 110-1 may initiate M nodes of the slave nodes 110-2 to 110-N to enter the sleep-state.

In block 250, the master node 110-1 may wake-up R nodes of the slave nodes 110-2 to 110-N identified to execute the K tasks. In block 260, the master node 110-1 may assign the tasks to the slave nodes in awaken or woken-up state.

In block 270, the master node 110-1 may wait until the slave nodes to complete computation of tasks. In block 280, the master node 110-1 may check for convergence after gathering the results of computation. In one embodiment, the master node 110-1 may collate the results of search criteria produced from each of the awaken slave nodes.

In block 285, the master node 110-1 may check whether the convergence is reached and control passes to block 220 if the convergence is not reached and to block 290 if the convergence is reached.

In block 290, the master node 110-1 may report the final results, which is collated from the results generated by the slave nodes.

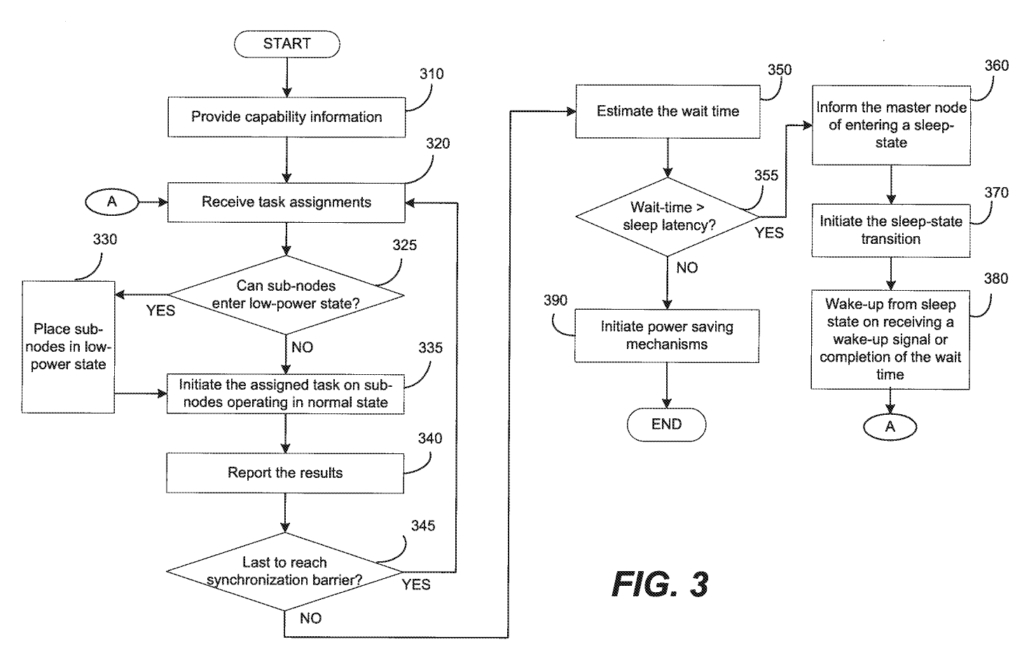

An embodiment of a slave node conserving power in a multi-node environment is illustrated in FIG. 3.

In block 310, the slave nodes 110-2 to 110-N may provide capability information. In one embodiment, the slave nodes 110-2 to 110-N may configure the fields of a broadcast packet received over the network and may return the packet to the master node 110-1. In one embodiment, the fields that are configured may represent the capabilities of the slave nodes 110-2 to 110-N.

In block 320, the slave nodes, for example 110-2 may receive an assignment of the task. In one embodiment, the slave node 110-2 may receive an assignment to traverse a first portion of the database to perform the search criteria.

In block 325, the slave node 110-2 may check whether the sub-nodes of the slave node 110-2 may enter the low-power state and may pass the control to block 330 if one or more sub-nodes may enter the low-power state and to block 335 otherwise. In one embodiment, the slave node 110-2 may check, for example, whether the I/O devices, memory, and the display of the slave node 110-2 may be transitioned into low-power state.

In block 330, the slave node 110-2 may cause the sub-nodes to transition to low-power state. In one embodiment, the slave node 110-2 may cause disk spin down, which may reduce the speed of rotation of the hard disk drive and may also cause the network interface to operate in D1 state.

In block 335, the slave node 110-2 may initiate the assigned task. In one embodiment, the slave node 110-2 may use the sub-nodes which may be sufficient to perform the assigned task and the other sub-nodes may be pushed into low-power state. In one embodiment, the slave node 110-2 may initiate one or more applications supported on the slave node 110-2 to search the first portion of the database.

In block 340, the slave node 110-2 may report the results of the search to the master node 110-1. In block 345, the slave node 110-2 may check whether the slave node 110-2 is the last node to reach the synchronization barrier and control passes to block 320 if the slave node 110-2 is the last node to reach the synchronization barrier and to block 350 otherwise.

In one embodiment, the synchronization barrier may refer to adjusting the time of occurrence of output from each of the slave nodes 110-2 to 110-N. In one embodiment, the synchronization may ensure the dependency of a node on the other may be satisfied.

In block 350, the slave node 110-2 may estimate the wait time. In one embodiment, the slave node 110-2 estimate the wait time for receiving the output generated by other slave node on which the slave node 110-2 is dependent on.

In block 355, the slave node 110-2 may check whether the wait time is greater than the sleep latency and control passes to block 360 if the wait time is greater than the sleep latency and to block 390 otherwise. In one embodiment, the sleep latency may refer to the time duration for which the slave node 110-2 may remain in sleep state after entering the sleep-state. In one embodiment, if the wait time is greater than the sleep latency, the slave node 110-2 may enter the sleep state as such an approach would conserve power.

In block 360, the slave node 110-2 may inform the master node 110-1 of entering a sleep-state. In one embodiment, the slave node 110-2 may send a packet to inform the master node 110-1 about the slave node 110-2 entering the sleep-state.

In block 370, the slave node 110-2 may initiate transition into the sleep-state. In block 380, the slave node 110-2 may wake-up from sleep-state in response to receiving a wake-up signal from the master node 110-1 or in response to completion of the wait time and control passes to block 320. In one embodiment, the slave node 110-2 may comprise a local timer, which may keep track of the wait time.

In block 390, the slave node 110-2 may initiate power conserving mechanism such as processor power management features such as the C states, memory self-refresh, and device management features such as D0 to D3.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A multi-node environment comprising:
a master node, and
a plurality of slave nodes coupled to the master node,
wherein the master node is to identify tasks and a first set of slave nodes of the plurality of slave nodes to perform the tasks and to cause a second set of nodes of the plurality of slave nodes to enter a low-power state,
wherein the first set of slave nodes is to cause a first set of sub-nodes of each of the first set of slave nodes to enter the low-power state before initiating an assigned task of the tasks to be performed on a second set of sub-nodes.

2. The multi-node environment of claim 1, wherein the master node is to identify the first set of slave nodes to perform the tasks if the tasks are less than the plurality of slave nodes.

3. The multi-node environment of claim 2, wherein the master node is to identify the first set of slave nodes, which have optimum resources to perform the tasks.

4. The multi-node environment of claim 3, wherein the master node is to wake-up the first set of slave nodes to perform the tasks.

5. The multi-node environment of claim 1, wherein the master node is to cause the second set of slave nodes to enter an advanced configuration power interface initiated system sleep state.

6. The multi-node environment of claim 2, wherein the master node is to assign the tasks to the plurality of slave nodes if the tasks are greater than the plurality of slave nodes.

7. The multi-node environment of claim 1, wherein the first set of slave nodes is to,
identify the first set of sub-nodes, which are not required to perform the assigned task, and
identify the second set of sub-nodes, which are required to perform the assigned task.

8. The multi-node environment of claim 7, wherein the first set of sub-nodes entering the low-power is to cause a network interface of the first set of sub-nodes to enter device sleep state.

9. The multi-node environment of claim 7, wherein each of the first set of salve nodes is to
estimate a wait time to receive inputs from other nodes of the first set of nodes if a node of the first set of slave nodes is the last to reach a synchronization barrier,
cause the node to enter into a sleep-state if the wait time is greater than a sleep latency, and
initiate power saving mechanisms if the wait time us less than the sleep-latency.

10. The multi-node environment of claim 9, wherein the node is to inform the master node before entering the sleep state.

11. The multi-node environment of claim 10, wherein the node is to wake-up from the sleep-state on receiving a wake-up signal from the master node.

12. The multi-node environment of claim 10, wherein the node is to wake-up from the sleep-state on elapsing of the wait time.

13. A method comprising:
identifying tasks managed by a master node,
performing the tasks in a first set of slave nodes of a plurality of slave nodes, wherein the first set of slave nodes is to cause a first set of sub-nodes of each of the first set of slave nodes to enter the low-power state before initiating an assigned task of the tasks to be performed on a second set of sub-nodes, and
causing a second set of nodes of the plurality of slave nodes to enter a low-power state.

14. The method of claim 13, wherein the master node is to identify the first set of slave nodes to perform the tasks if the tasks are less than the plurality of slave nodes.

15. The method of claim 14 comprises waking-up the first set of slave nodes to perform the tasks, wherein the master node is to wake-up the first set of slave nodes.

16. The method of claim 14 comprises assigning the tasks to the plurality of slave nodes if the tasks are greater than the plurality of slave nodes, wherein the assigning is performed by the master node.

17. The method of claim 13 further comprises the first set of slave nodes,
identifying the first set of sub-nodes, which are not required to perform the assigned task, and
identifying the second set of sub-nodes, which are required to perform the assigned task.

18. The method of claim 17 comprises each of the first set of salve nodes,
estimating a wait time to receive inputs from other nodes of the first set of nodes if a node of the first set of slave nodes is the last to reach a synchronization barrier,
causing the node to enter into a sleep-state if the wait time is greater than a sleep latency, and
initiating power saving mechanisms if the wait time us less than the sleep-latency.

19. The method of claim 18 comprises the node waking-up from the sleep-state in response to receiving a wake-up signal from the master node.

20. The method of claim 18 comprises the node waking-up from the sleep-state in response to elapse of the wait time.
